(19) United States
(12) Patent Application Publication
(10) Pub. No.: US 2010/0056121 A1
(43) Pub. Date: Mar. 4, 2010

(54) SYSTEM AND METHOD FOR SIMULTANEOUS CONVERSATION IN MULTI-PARTY

(76) Inventor: Zhongwen CHEN, Dongguan (CN)

Correspondence Address: SCIHEAD INTELLECTUAL PROPERTY LAW GROUP, LTD, Huihua Commercial & Trade Building, Suite 1508, 80 Xian Lie Zhong Road, Guangzhou, 51070, CN

(21) Appl. No.: 12/198,124

(22) Filed: Aug. 26, 2008

(51) Int. Cl. H04M 3/42

(52) U.S. Cl. 455/416

(57) ABSTRACT

A method for simultaneous multi-party conversation, comprising steps of: (1) a calling party dialling a called party resulting in the voice signal of the calling party being directed into a computer of the calling party; (2) said computer transmitting the voice signal to a plurality of computers of called parties and activating several internet voice communication softwares of the called parties; (3) the voice signal of one of the called parties being received by the calling party; (4) then, the voice signal of the called party being transmitted to other called parties by a transforming device, thus achieving interconnection between the calling party and several called parties. Said method and system also comprise a step of conversation recordation. The invention also discloses a system for simultaneous multi-party conversation.

### FIELD OF THE INVENTION

The invention relates to a system and method for simultaneous conversation in multi-party, particularly to a system and method for simultaneous conversation in a multi-party where various communication softwares can be used at the same time.

### BACKGROUND OF THE INVENTION

In today's information society, with the development of home computer, communications in internet have gradually become popular tools of communications due to it's advantages of wide communication range, low cost and convenience. Current software which is widely known and frequently used includes QQ, ICQ, SKYPE, MSN and NETMEETING

Although aforementioned softwares are widely used, many problems of such internet communication system are still present. Firstly, conversation can be performed only by a single communication software. Conventional internet communication software includes an access module and an operating module both provided by a software developer. When utilizing the software, one party should log in by the access module firstly, then call another party or receive conversation from another party with voice signal of the calling party and/or called party being transmitted avoidlessly over the host server of the software developer; but in modern common marketplace, there exist various types of internet communication software developped by different software developers and consumer may select different software according to different requirement, thus the conversation can be performed only by a particular internet software which is being used by both the calling party and the called party at the same time. Secondly, the content of the conversation of parties cannot be recorded to form voice file simultaneously during the real-time conversation of the parties. Thirdly, crosstalk or feedback between the transmitter and the receiver of conventional communication system is inherently generated deteriorating the quality of conversation. All abovementioned problems totally produce great difficulty and unconvenience for users.

Therefore it is very important to provide a system and method for simultaneous conversation in multi-party to address abovementioned problems

### SUMMARY OF THE INVENTION

To resolve problems of prior art, a practicable method for simultaneous multi-party conversation of the invention is provided for customers to use based on individual need and selectivity of communicating quality of different internet voice communication software.

One object of the invention is to provide a practicable system for simultaneous multi-party conversation, the volume and cost of which is small. Customers can use the system based on individual need and selectivity of communicating quality of different internet voice communication software.

Another object of the invention is to provide a system for simultaneous multi-party conversation for recording conversation and remaining conversation as recordation file in purpose of later research and study via a recording software loaded in a computer.

To achieve above objects, a method for simultaneous multi-party conversation is provided comprising: (1) a calling party dialling a called party, thereby the voice signal originated from the calling party is converted and transmitted into a computer of the calling party by a telecommunication device, the computer of the calling party being loaded with a variety of internet voice communication software and a transforming device; (2) said computer of the calling party transmitting the voice signal of the calling party to a plurality of computers connected to corresponding called parties over internet and activating respective internet voice communication softwares loaded in the computers of the called parties, so that achieving connection to several called parties; (3) when one of said called parties speaking, the voice signal thereof being transmitted to the computer of the calling party through the computer of said called party; (4) then, the voice signal of the called party being transmitted to other called parties by the transforming device incorporated in the computer of the calling party, thus achieving interconnection between the calling party and several called parties via different internet voice communication softwares.

According to one embodiment of the present invention, said method also comprises a step of conversation recordation by a recording software loaded in said computer of the calling party.

A system for simultaneous multi-party conversation is also provided, comprising a plurality of computers, wherein said each computer has an integrated transmitting/receiving device and is loaded with at least one internet voice communication software, and at least one computer is loaded with a plurality of internet voice communication softwares; said system further comprising at least one transforming device incorporated in at least one of said computers.

In one embodiment of the invention, said transforming device is mounted on a motherboard or soundcard of said computer by a connector. At least one of said computers is loaded with a recording software for recording multi-party conversation in real time. The system further comprises internet phone such as a cable phone or a wireless phone for directing voice signal to said computers. Said each computer comprises a transmitter and a receiver. Said computers can be grouped into calling party computer and called party computers, said transforming device being mounted into said calling party computer. Said calling party computer is loaded with a plurality of internet voice communication softwares and said called party computers each is loaded with at least one internet voice communication software. In one embodiment of the invention, said called parties can be loaded with said transforming devices and function as the calling party, and said called parties can communicate with additional sub-called parties via internet. More than one said transforming device can be used in said system and each pair of said transforming devices are coupled with a switch. Said integrated transmitting/receiving device is a two-portioned earphone/microphone.

The transforming device is installed into said computer, thereby greatly reducing the space and cost of the transforming device, without changing natural functions and volumes of the soundcard or motherboard, and making it applicable and cost-effective.

In addition, the method and system of the invention make it possible for customer to select different communication software with different communicating quality based on individual need, thus achieving multi-party conversation via various communication softwares. Due to the characteristics of voice signal being directly input into a computer, it is possible to apply the system and method of the invention to multi-party chatting or internet telephone conferencing directly and cost-effectively and conveniently. Simultaneous multi-party conversation using different communication softwares and recordation of the conversation in real time is thus achieved by utilization of the system and method of the invention.

Furthermore, the voice signal of one of a called party can be transmitted to and received by a calling party as well as other called parties. The recordation of the conversation can be delivered to correspondent persons and recorded again without destroying the original recordation, thus making the conversation convenient, fast and cost-effective, breaking through the limitation of the number of parties and compatibility of the communication softwares, also saving the time consumed in study of the conversation by persons associated with the system because of study being performed synchronously by all persons.

To better understand the invention, the embodiments of the invention will be described in greater detail in conjunction with the drawings.

### DESCRIPTION OF THE DRAWINGS

FIG. 1 is a schematic diagram of the simultaneous multi-party conversation of the invention;

FIG. 2 is a schematic diagram of the simultaneous multi-party conversation of a first embodiment of the present invention;

FIG. 2a is a schematic diagram of the simultaneous multi-party conversation of a second embodiment of the present invention;

FIG. 2b is a schematic diagram of the simultaneous multi-party conversation of a third embodiment of the present invention;

FIG. 3 is a schematic diagram of the simultaneous multi-party conversation of a fourth embodiment of the present invention;

FIG. 4 is an isometric view showing a transforming device being mounted to a soundcard of a computer.

### DETAILED DESCRIPTION OF THE INVENTION

A method for simultaneous multi-party conversation, comprising steps of: (1) a calling party dialling a called party, thereby the voice signal originated from the calling party is converted and transmitted into a computer of the calling party by a telecommunication device, the computer of the calling party being loaded with a variety of internet voice communication softwares and a transforming device; (2) said computer of the calling party transmitting the voice signal of the calling party to a plurality of computers connected to corresponding called parties over internet and activating respective internet voice communication software loaded in the computers of the called parties, so that achieving connection to several called parties; (3) when one of said called parties speaking, the voice signal thereof being transmitted to the computer of the calling party through the computer of said called party; (4) then, the voice signal of the called party being transmitted to other called parties by the transforming device incorporated in the computer of the calling party, thus achieving interconnection between the calling party and several called parties via different internet voice communication softwares.

According to one embodiment of the present invention, said method also comprises a step of conversation recordation by a recording software loaded in said computer of the calling party.

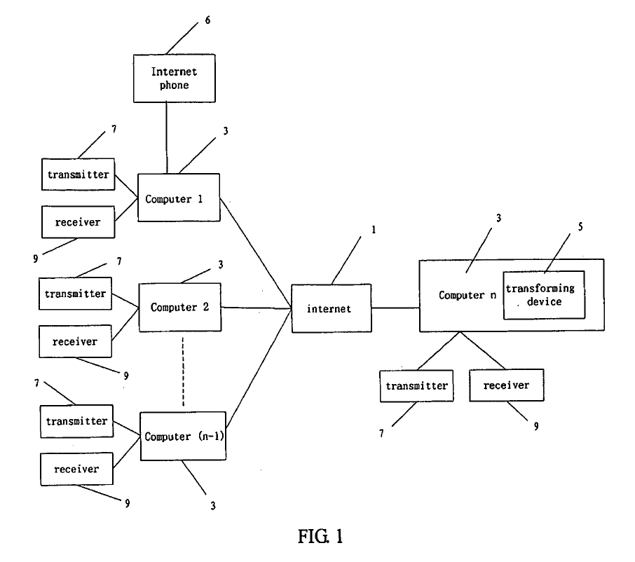

Referring to FIG. 1, a system for simultaneous multi-party conversation of the invention comprising internet 1, a plurality of computers 3 capable of connecting to said internet 1 and a transforming device 5. Each computer 3 includes a transmitter 7 and a receiver 9 incorporated therein. At least one computer 3 is loaded with a recording software. Said transmitter 7 has a microphone integrated therewith, and the transmitter 7 can accept voice signal through the transforming device 5 without echo being generated and fed back to the transmitter 7 and degrading the quality of communication. Said transmitter 7 and said receiver 9 are electrically coupled together by a connecting wire. Said connecting wire is designed specially and structured to substantially prevent the crosstalk or feedback between the transmitter 7 and receiver 9. Said communication system further comprises a plurality of internet phones 6 (only shown in the first computer, the same case as other computers) capable of guiding voice signal to said computers 3, such as cable telephone or wireless telephone.

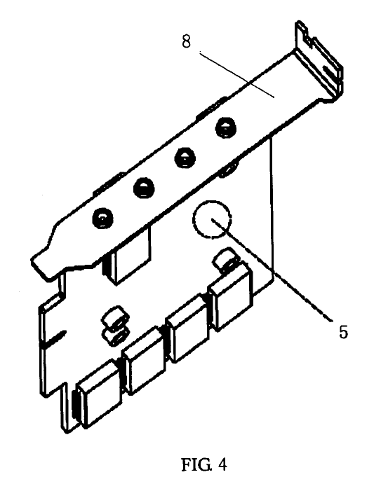

Said transforming device 5 is embedded into said computer 3. In one embodiment of the present invention, said transforming device 5 is mounted on a soundcard 8 of a computer 3 (shown in FIG. 4). Said transforming device 5 functions by connecting to a sound circuit (not shown) with a sound connector (not shown). In another embodiment of the present invention, said transforming device 5 achieves switching function by being mounted itself to a motherboard of a computer 3. In embodiments of the present invention, the transforming device 5 is installed into said computer 3, thereby greatly reducing the space and cost of the transforming device 5, without changing natural functions and volumes of the soundcard or motherboard, and making it applicable and cost-effective.

Said computers can be categorized into two groups, one group consisting of a calling party computer (such as computer N) and another group consisting of called party computers (such as computers labeled with numbers from 1 to (N-1)). Said transforming device 5 is connected to said calling party computer (such as computer N). Said calling party computer is loaded with a plurality of internet voice communication softwares and said called party computers each is loaded with at least one such software. Said internet voice communication software transmits voice signal and said recording software records the voice signal simultaneously during conversation between parties.

The calling party can activate simultaneously several said internet voice communication softwares and call any called party using respective internet voice communication software via a calling party computer 3 with access to the internet and configured with a transforming device, and then achieve multi-party simultaneous intercommunications between parties using different internet voice communication softwares by the support of said transforming device 5 (such as an audio transforming device).

Of course, said system for simultaneous multi-party communication can also activate the recording software loaded in said computer 3 and the content of conversation can be recorded at the same time by said recording software and transformed in form of voice material. Said voice material may be delivered to corresponding persons and researched by such persons at the same time, so that reducing time consumed in listening and researching the content. In the present invention, said called party can function as a calling party when installed the transforming device 5 and vice versa.

All parties should get corresponding accounts (virtual telephone numbers) and passwords of these internet voice communication softwares and are connected to the internet capable of carrying big amount of dataflow. Conversation is achieved by dialling virtual telephone number of another party.

For better understanding of the present invention, two embodiments of the invention will be described below.

### First Embodiment

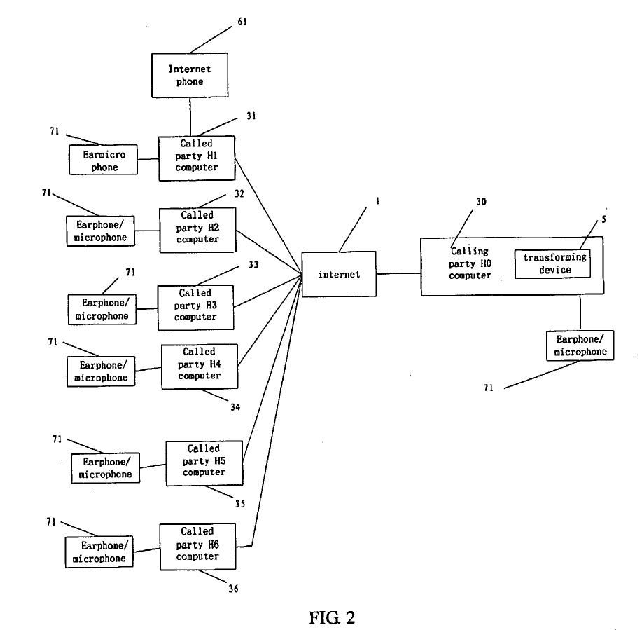

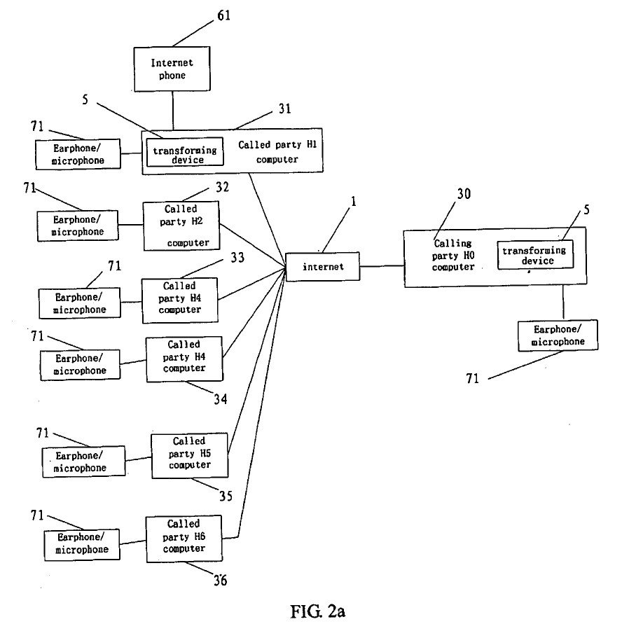

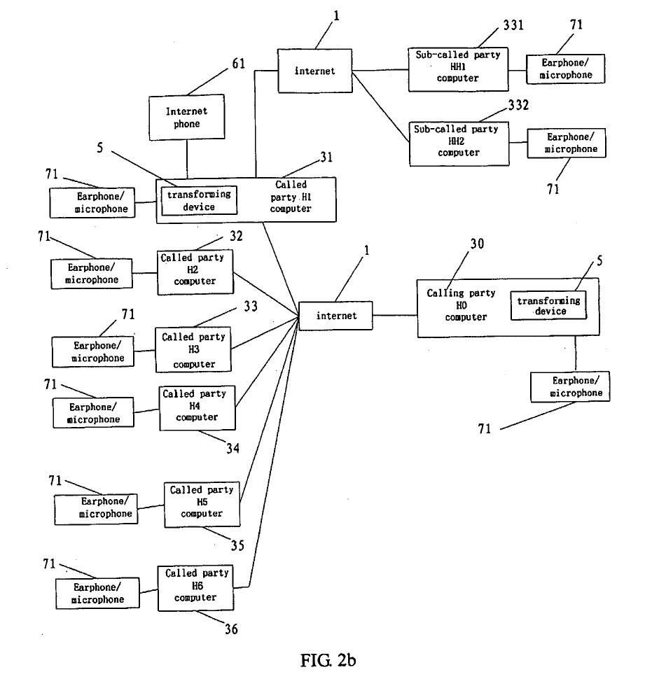

Referring to FIG. 2, according to a first embodiment, a system for simultaneous multi-party communication is performed by means of:

A transforming device 5 is mounted on internet-accessible computer 30 of a calling party HO. In one embodiment of the invention, the transforming device 5 is mounted inside of the computer 30. The calling party H0 connects a called party by dialing the called party, and the called party gets in conversation with the calling party H0 by activating internet voice communication software installed in a computer with access to the internet.

For example, assuming that internet voice communication software that may be used by all parties includes QQ, MSN, SKYPE, NETMEETING, POPO and UC, correspondingly there are six parties, i.e. called party H1, H2, H3, H4, H5 and H6 which each uses a different computer, namely, computer 31, 32, 33, 34, 35 and 36. Each computer comprises a transmitter and a receiver.

As can be seen in FIG. 2, the voice signal originated from the called party H1 also can be converted to computer-identifiable signal in said computer 31 via internet phone 61, such as a cable phone or a wireless phone (for example, a mobilephone). By using the internet phone 61, communication between multi-party with multi software can be achieved. Clearly, the voice signal of other calling or called party can also be converted to correspondent computer.

In this embodiment, the transmitter and the receiver are integrated as a whole earphone/microphone 71. The earphone/microphone 71 of a calling party is connected to a transforming device 5.

The called party H1 uses QQ, H2 uses MSN, H3 uses SKYPE, H4 uses NETMEETING, H5 uses POPO and H6 uses UC as their respective inter voice communication software. The calling party uses QQ, MSN, SKYPE, NETMEETING, POPO and UC to call H1 which uses QQ, H2 which uses MSN, H3 which uses SKYPE, H4 which uses NETMEETING; H5 which uses POPO and H6 which uses UC.

The voice of the calling party can be transmitted to the six called parties by internet voice communication softwares. In conversation, voice signal of any one of the six called parties can be transmitted directly to the computer 30 of the calling party and picked up by the calling party, at the same time, the voice signal received by the computer 30 is converted and transmitted by said transforming device 5, thus multi-party conversation through various internet voice communication softwares is achieved.

When activated by the calling party, the recording software loaded in the computer 30 of the calling party can real-timely record multi-party conversation. The voice of the calling party H0 can be recorded by directly inputting such voice to the computer 30, while the voice of any one of the called parties can be real-timely recorded by the recording software through inputting the voice itself indirectly via said transforming device 5, so that multi-party communication and real-time recordation of the conversation can be performed synchronously. In the present invention, the recordation can be recorded again and quality of original recordation still maintains at a high level.

### Second Embodiment

Referring to FIG. 2a, according to a second embodiment of the invention, a system for simultaneous multi-party communication is constructed by modifications based on the system of the first embodiment. Detailed description is as below:

The computer 31 of the called party Hi is configured with a transforming device 5, and an earphone/microphone 71 is connected to the computer 31 via said transforming device 5. The computer 31 of the called party H1 is also installed with a various internet voice communication softwares. By above configuration, said called party H1 accordingly operates as a calling party and can be regarded as a calling party in fact, thereby can communicates with other calling or called parties. Apparently, a recording software may be loaded to the computer 31 of the called party H1 to realize real-time multi-party conversation. Of course, the aforementioned configuration of the computer 31 of the called party H1 can be applied to other computers of corresponding called parties such as 32, 33, 34, 35 and 36, and these called parties function similarly to the called party H1. Detailed description of these computers is omitted herefrom.

### Third Embodiment

Referring to FIG. 2b, according to a third embodiment of the invention, a system for simultaneous multi-party communication is constructed by modifications based on the system of the second embodiment. Detailed description is as below:

Several computers such as 331, 331 of several sub-called parties such as HH1, HH2 are connected to the computer 31 of the called party H1. Said computers 331, 331 each is configured with a transmitter and receiver. In a third embodiment of the invention, the transmitter and receiver are integrated together so that forming an earphone/microphone 71. The computers 331, 332 of the sub-called parties HH1, HH2 each is loaded with at least one internet voice communication software. In this case, the called party H1 enables to communicate with either calling parties or sub-called parties such as HH1, HH2. Of course, other computers of the called parties can take similar configuration as that of the computer 31 of the called party H1 and perform the similar function as that of the called party H1. Detailed description of these computers is omitted herefrom.

### Fourth Embodiment

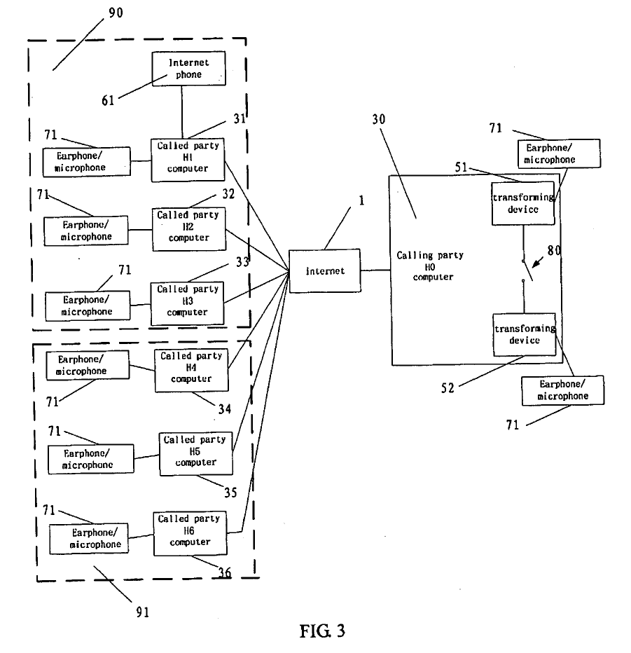

Referring to FIG. 3, according to a fourth embodiment of the invention, a system for simultaneous multi-party communication is achieved by means of:

The computer 30 of the calling party H0 is connected to internet and equipped with two transforming devices 51 and 52. The called party can activate the internet voice communication software loaded in the computer of the called party via the computer thereof and is connected to the calling party H0, when the called party is called by the calling party H0. Two soundcards are installed into said computer 30 (only a soundcard is installed into a conventional computer), and in one embodiment of the invention, the transforming devices 51, 52 may be installed into said two soundcards (not shown). The two transforming devices 51, 52 are connected together via a switch 80, by altering on position and off position of which, one or both of two transforming devices 51, 52 can be switched on for using by left/right ear of an individual or two individuals. Said earphone/microphone 71 comprises an earpiece and a microphone both of which can be selectively switched on or off for receiving information by left or right ear independently. Each computer comprises a transmitter and a receiver one or both of which can be selected for using. Said earphone/microphone 71 may be constructed by two portions for easily controlling transmitting or receiving of information. In this embodiment, the transmitter and receiver may be integrated together so that forming an earphone/microphone 71 which may be a two-portioned structure for selectively switching on/off the earpiece or microphone. Said computer 30 of the calling party H0 is connected to transforming devices 51 and 52.

As can be seen in FIG. 3, the voice signal of the called party H1 can be received by said computer 31 thereof via internet phone 61 which may be a cable phone or wireless phone such as a mobilephone. By using the internet phone 61, communication between multi-party with multi software can be achieved. Clearly, the voice signal of other calling or called party can also be received by correspondent computer.

For clearly understanding, an example is taken below. Assuming that internet voice communication software that may be used by all parties includes QQ, MSN, SKYPE, NETMEETING, POPO and UC, correspondingly there are six parties, i.e. called party H1, H2, H3, H4, H5 and H6 which each uses a different computer, namely, computer 31, 32, 33, 34, 35 and 36.

Described is a first system using QQ, MSN and SKYPE as it's internet voice communication softwares. The voice signal originated from the calling party H0 can be transmitted via internet voice communication software installed in the computer of the calling party H0 to two called parties and received by called parties completely. When in conversation, voice signal of a called party can be transmitted to the computer of the calling party H0 and picked up by the calling party H0, and subsequently the voice signal is transmitted via transforming devices 51, 52 to other called parties.

Described now is a second system using NETMEETING, POPO and UC as it's internet voice communication softwares. The voice signal originated from the calling party H0 can be transmitted via internet voice communication software installed in the computer of the calling party H0 to two called parties and received by called parties completely. When in conversation, voice signal of a called party can be transmitted to the computer of the calling party H0 and picked up by the calling party H0, and subsequently the voice signal is transmitted via transforming devices 51, 52 to other called parties. The multi-party conversation of the first and second system can be recorded simultaneously by a recording software loaded in the computer 30 of the calling party H0. The voice of the calling party H0 can be input into the computer 30 directly and recorded, and correspondingly, the voice of one called party can be converted by the transforming devices 51, 52 and input into the computer 30 to be recorded by the recording software loaded in the computer 30. By structure described above, two system of multi-party can realize interconnection therebetween, and conversation thereof can be recorded in real time. By switching on the on-off switch 80, two systems can communicate with each other. By equipped with compatible soundcards and corresponding transforming devices, interconnection between multi-system of multi-party using different communication softwares and recordation thereof can be achieved.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A method for simultaneous multi-party conversation, comprising steps of:
(1) a calling party dialling a called party, thereby the voice signal originated from the calling party is converted and transmitted into a computer of the calling party by a telecommunication device, the computer of the calling party being loaded with a variety of internet voice communication softwares and a transforming device;
(2) said computer of the calling party transmitting the voice signal of the calling party to a plurality of computers connected to corresponding called parties over internet and activating respective internet voice communication software loaded in the computers of the called parties, so that achieving connection to several called parties;
(3) when one of said called parties speaking, the voice signal thereof being transmitted to the computer of the calling party through the computer of said called party; and
(4) the voice signal of the called party being transmitted to other called parties by the transforming device incorporated in the computer of the calling party, thus achieving interconnection between the calling party and several called parties via different internet voice communication softwares.

2. The method for simultaneous multi-party conversation as claimed in claim 1, further comprising a step of conversation recordation performed by a recording software loaded in the computer of the calling party.

3. A system for simultaneous multi-party conversation using various internet voice communication softwares, comprising a plurality of computers, wherein said each computer has an integrated transmitting/receiving device and is loaded with at least one internet voice communication software, and at least one computer is loaded with a plurality of internet voice communication softwares; said system further comprising at least one transforming device incorporated in at least one of said computers.

4. The system for simultaneous multi-party conversation as claimed in claim 3, wherein said integrated transmitting/receiving device is a two-portioned earphone/microphone including an earpiece and a microphone, both of which can be switched on or off freely; said transforming device is coupled to said computer by a connecter.

5. The system for simultaneous multi-party conversation as claimed in claim 3, wherein said transforming device is mounted on a motherboard or soundcard of said computer.

6. The system for simultaneous multi-party conversation as claimed in claim 5, wherein at least one of said computers is loaded with a recording software for recording multi-party conversation in real time.

7. The system for simultaneous multi-party conversation as claimed in claim 6, further comprising internet phone for directing voice signal to said computers.

8. The system for simultaneous multi-party conversation as claimed in claim 7, wherein said called parties can be loaded with said transforming devices and function as the calling party, and said called parties can communicate with sub-called parties via internet.

9. The system for simultaneous multi-party conversation as claimed in claim 8, wherein said computers can be grouped into a calling party computer and called party computers, said transforming device being mounted into said calling party computer, said each computer comprising a transmitter and a receiver; said calling party computer is loaded with a plurality of internet voice communication softwares and said called party computers each is loaded with at least one internet voice communication software.

10. The system for simultaneous multi-party conversation as claimed in claim 9, wherein a plurality of transforming devices can be used in said system and each pair of said transforming devices are coupled with a switch.
